(19) United States
(12) Patent Application Publication
(10) Pub. No.: US 2026/0024264 A1
(43) Pub. Date: Jan. 22, 2026

(54) METHOD AND APPARATUS FOR PERSONALIZED VIDEO CONTENT MODIFICATION

(71) Applicant: KAKAO CORP., Jeju-si (KR)

(72) Inventors: Kyu Shik MIN, Seongnam-si (KR); Joong Kil SHIN, Seongnam-si (KR); Su In LEE, Seongnam-si (KR); Soo Hee BAEK, Seongnam-si (KR)

(73) Assignee: KAKAO CORP., Jeju-si (KR)

(21) Appl. No.: 19/272,824

(22) Filed: Jul. 17, 2025

(30) Foreign Application Priority Data
Jul. 17, 2024 (KR) 10-2024-0094530

(51) Int. Cl. G06T 13/40; G06Q 30/0251; G06T 13/20; G10L 13/00; G10L 15/26

(52) U.S. Cl. CPC G06T 13/40; G06Q 30/0271; G06T 13/205; G10L 13/00; G10L 15/26

(57) ABSTRACT

Provided is a method and apparatus for video synthesis. The method includes obtaining an advertising target section from a video and sampling speech data of a target speaker from at least part of the audio track. The audio track corresponding to the target speaker is then changed into speech synthesis data, wherein the target speaker utters an advertising script related to an advertising object. In parallel, the lip movement of the target speaker in the video track is modified to match the utterance of the advertising script. This approach allows for seamless integration of personalized advertisements into video content by synchronizing both speech and visual lip movements with the advertising script.

### CROSS-REFERENCE TO RELATED APPLICATION

This application claims the benefit of Korean Patent Application No. 10-2024-0094530 filed on Jul. 17, 2024, in the Korean Intellectual Property Office, the entire disclosure of which is incorporated herein by reference for all purposes.

### BACKGROUND

### Technical Field

One or more embodiments relate to a method and apparatus for advertising.

### Description of the Related Art

Product placement (PPL) refers to advertising company's products directly or indirectly to consumers by featuring the products as props or backgrounds in entertainment content such as movies, television (TV) series, music videos, game software, and the like. Recently, as content consumption through terminals increases, various contents distributed through terminals are being used as a medium for PPL. As advertising media diversify, the development of a technology for PPL is required to reduce advertising costs and naturally adding advertisements into content.

### BRIEF SUMMARY

The described method and system enable the seamless integration of personalized advertisements into existing video content by replacing a specific section of the video with synthesized audio and visually synchronized lip movements. It identifies a segment in which a character speaks a phrase related to an advertising object, then generates a new audio track in the same speaker's voice using sampled speech data and a text to speech model. At the same time, the character's lip movements in the video are adjusted to match the new advertising script, allowing for natural alignment without the need to re-record or alter the original content structure.

The system also facilitates personalized advertisement delivery by preparing multiple variations of advertisement segments in advance and selecting the most relevant one based on individual user characteristics such as demographic information or viewing behavior. This approach allows for dynamic delivery of tailored advertisements within video playback by using stored or transcribed text, speech encoding, clustering techniques, and visual lip synchronization models.

For example, various embodiments provide a technology for changing a partial section in a video into a video in which an advertising script regarding an advertising object is uttered.

Embodiments provide a technology for streaming a video that include a customized advertisement.

However, the technical aspects are not limited to the aforementioned aspects, and other technical aspects may be present.

According to an aspect, there is provided a method of video synthesis performed by a server, the method including obtaining an target section from a video, sampling speech data of a target speaker corresponding to the target section from at least a portion of an audio track of the video, changing an audio track corresponding to the target speaker in the target section into speech synthesis data of the target speaker uttering a script regarding a target object based on the sampled speech data of the target speaker, and changing a lip movement of the target speaker in a video track of the target section to a lip movement for uttering the script.

The obtaining of the target section may include obtaining text data corresponding to the audio track, extracting a text corresponding to the target object from the text data, and obtaining the target section corresponding to the extracted text from the video.

The obtaining of the text data may include at least one of obtaining the text data previously stored corresponding to the video, and obtaining the text data by transcribing the audio track.

The obtaining of the target section may include extracting the target section based on tagging information about the target object included in the video.

The sampling of the speech data of the target speaker may include obtaining section-wise embedding data of the audio track by applying the audio track to a speech encoder, and extracting a section, in which it is determined that the target speaker has uttered, based on a similarity between the section-wise embedding data.

The extracting of the section, in which it is determined that the target speaker has uttered, may include obtaining a similarity between each cluster obtained as a result of clustering the section-wise embedding data and a cluster of the target section, and extracting a section corresponding to a cluster that is determined to have the same speaker as the cluster of the target section based on the similarity.

The changing of the lip movement may include identifying a character estimated as the target speaker based on a lip movement pattern of a character of the video track of the target section, and changing a lip movement of the character estimated as the target speaker in the video track of the target section to the lip movement for uttering the script.

The changing of the lip movement may include segmenting a mouth region of a character in the video track of the target section, and obtaining the video track of the target section, in which the mouth region is changed to have the lip movement for uttering the script.

According to another aspect, there is provided a method of video synthesis performed by a server, the method including obtaining chunk information in which a target section of a video is converted into speech synthesis data and lip movement data of a target speaker corresponding to each of candidate objects, selecting a target object corresponding to a user from among the candidate objects based on a feature of the user who has requested the video, and providing chunk information corresponding to the selected target object corresponding to the target section to a terminal of the user.

The obtaining of the chunk information may include obtaining the target section from the video, sampling speech data of a target speaker corresponding to the target section from an audio track of the video, synthesizing a speech of the target speaker uttering a script regarding each candidate object based on the sampled speech data of the target speaker, changing a lip movement of the target speaker in a video track of the target section to a lip movement for uttering the script regarding each candidate object, and generating a chunk corresponding to each candidate object, in which the target section is changed into a video track including the changed lip movement and the synthesized speech data.

The providing of the chunk information may include providing the video to the terminal of the user by replacing the target section with a video segment corresponding to the chunk information.

The terminal of the user may play a replaced video with the target section based on the chunk information.

The candidate objects may be included in one group corresponding to the target section.

According to another aspect, there is provided a server, including at least one processor including processing circuitry, and memory storing instructions that, when executed by the at least one processor individually or collectively, cause the server to obtain a target section from a video, sample speech data of a target speaker corresponding to the target section from at least a portion of an audio track of the video, change an audio track corresponding to the target speaker in the target section into speech synthesis data of the target speaker uttering a script regarding a target object based on the sampled speech data of the target speaker, and change a lip movement of the target speaker in a video track of the target section to a lip movement for uttering the script.

The instructions, when executed by the at least one processor individually or collectively, may cause the server to obtain text data corresponding to the audio track, extract a text corresponding to the object from the text data, and obtain the target section corresponding to the extracted text from the video.

The instructions, when executed by the at least one processor individually or collectively, may cause the server to obtain the text data previously stored corresponding to the video, and obtain the text data by transcribing the audio track.

The instructions, when executed by the at least one processor individually or collectively, may cause the server to obtain section-wise embedding data of the audio track by applying the audio track to a speech encoder, and extract a section, in which it is determined that the target speaker has uttered, based on a result of clustering of the section-wise embedding data.

The instructions, when executed by the at least one processor individually or collectively, may cause the server to identify a character estimated as the target speaker based on a lip movement pattern of a character of the video track of the target section, and change a lip movement of the character estimated as the target speaker in the video track of the target section to the lip movement for uttering the script.

According to another aspect, there is provided a server, including at least one processor including processing circuitry, and memory storing instructions that, when executed by the at least one processor individually or collectively, cause the server to obtain chunk information in which a target section of a video is converted into speech synthesis data and lip movement data of a target speaker corresponding to each of candidate objects, select a target object corresponding to a user from among the candidate objects based on a feature of the user who has requested the video, and provide chunk information corresponding to the selected target object corresponding to the target section to a terminal of the user.

In sum, the disclosed method addresses technical limitations of conventional advertising systems that require manual video editing or re-recording to reflect advertisement changes. The disclosed system provides a specific, technical solution by automatically modifying audiovisual content within a video stream using speech synthesis, lip movement generation, and speaker-specific audio embeddings, enabling scalable and dynamic customization without disrupting playback or requiring content creators to produce multiple versions of the same media.

### BRIEF DESCRIPTION OF THE SEVERAL VIEWS OF THE DRAWINGS

These and/or other aspects, features, and advantages of the disclosure will become apparent and more readily appreciated from the following description of embodiments, taken in conjunction with the accompanying drawings of which:

FIG. 1 is a flowchart of operations of an advertising method according to an embodiment;

FIG. 2 is a diagram illustrating a framework of a model for performing an advertising method according to an embodiment;

FIG. 3 is a diagram illustrating a method of sampling speech data of a target speaker according to an embodiment;

FIG. 4 is a flowchart of an operation of an advertising method for providing a video including a customized advertising target section according to an embodiment;

FIG. 5 is a diagram illustrating a framework of a model for performing an advertising method according to an embodiment;

FIG. 6 is a diagram illustrating an operation of providing a customized advertising target section according to an embodiment; and

FIG. 7 is a diagram illustrating an example of a configuration of a server according to an embodiment.

### DETAILED DESCRIPTION

The following detailed structural or functional description is provided as an example only and various alterations and modifications may be made to the examples. Accordingly, the examples are not construed as limited to the disclosure and should be understood to include all changes, equivalents, and replacements within the idea and the technical scope of the disclosure.

In connection with the description of the drawings, like reference numerals may be used for similar or related components. It is to be understood that a singular form of a noun corresponding to an item may include one or more of the things, unless the relevant context clearly indicates otherwise.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Terms such as “1st” and “2nd,” or “first” and “second” may be used to simply distinguish a corresponding component from other components, and do not limit the components in other aspects (e.g., importance or order). For example, a first component may be referred to as a second component, or similarly, the second component may be referred to as the first component.

It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via a third component.

As used herein, the singular form is intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, a ‘target section’ refers to a specific segment of a video, comprising both audio and video tracks, that is identified for modification based on its relevance to an advertising object. This segment includes at least one portion where a character utters a word or phrase associated with the advertising object (also referred to as a “replacement word”) and may also include a preceding or following portion to ensure seamless integration. The target section may be identified through analysis of transcribed text data, tagging information, or audio feature clustering, and typically corresponds to a continuous speech unit or a predefined number of frames surrounding the relevant utterance.

As used herein, a ‘target object’ is an entity that is the subject of an advertisement to be presented within the target section. The target object may include, but is not limited to, a specific product, brand, or service. The target object is used to generate a customized advertising script and may be selected based on factors such as user profile data, advertisement groupings, or predefined campaign parameters.

As used herein, ‘chunk information’ refers to data generated for a specific target section of a video, where the section has been modified to reflect an advertising script corresponding to a candidate object. Each chunk includes speech synthesis data in which a target speaker is made to utter the advertising script in a voice that reflects the speaker's original characteristics. Each chunk includes lip movement data in which the visual representation of the speaker's mouth in the video track is adjusted to correspond to the synthesized speech. The chunk information may be stored in association with a particular candidate object and may also include metadata or control instructions for replacing the original target section with the modified content at the time of playback or delivery to a user terminal. In some implementations, multiple chunks may be generated in advance for a single target section, with each chunk corresponding to a different candidate object, allowing for real-time personalization based on user-specific features.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

Hereinafter, an advertising method will be described as an example of a video synthesis method. For example, a video generated through a video synthesis method may be provided as advertising content. A synthesis method for generating a video that is provided as advertising content may be referred to as an advertising method.

Hereinafter, a case where a target is an advertising target section, an object is an advertising object, and a script is an advertising script will be described as an example.

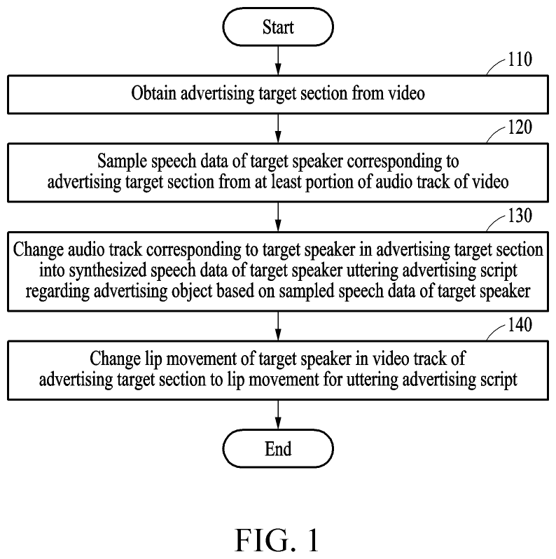

FIG. 1 is a flowchart of operations of an advertising method according to an embodiment.

The advertising method according to an embodiment may be performed on a server that provides a video service to a terminal of a user. For example, the video service may include a service that provides a video to a terminal of a user that has requested the video and/or an over-the-top (OTT) media service.

The advertising method according to an embodiment may be performed on a server linked to an advertising video service. For example, the server linked to the video service may include a server that generates information for converting at least a partial section of the video provided to the terminal of the user into a speech and/or an image corresponding to an advertising object. Hereinafter, the server for performing the advertising method according to an embodiment may be simply referred to as a “server.” The specific hardware configuration of the server will be described in detail below.

The advertising method according to an embodiment may include operation 110 of obtaining an advertising target section from a video. The video may include at least one of a video stored in the server, a video provided from the server to the terminal of the user, and a video streamed on the server.

The advertising target section may correspond to a partial section in the video to be replaced with a video corresponding to the advertising object. The advertising target section may include at least a frame sequence included in the video. The advertising target section is a section related to the advertising object, and may include, for example, a section in which a text corresponding to the advertising object is uttered.

The advertising target section may correspond to a section in which product placement (PPL) for a specific advertising object is inserted within the video. The advertising object is a target to be advertised, which may include at least one of a specific product, a service, and a brand. For example, the advertising target section may correspond to a section in which the advertising object is exposed, such as when a character in the video mentions at least one of a product name, a brand name, and a feature of the advertising object.

The text corresponding to the advertising object may be a text to be replaced with an advertising script for the advertising object, and may be a text that displays one or more syllables. For example, the text corresponding to the advertising object may include at least one of an item name of the advertising object, a name of an item that is identical to the item of the advertising object, and another product name of an item that is identical or similar to the advertising object. More specifically, for example, when the item of the advertising object is a sausage and the product name is A, the text corresponding to the advertising object may include at least one of “sausage,” “ham,” which is an item similar to the sausage, a product name B of the sausage item, a product name C of the ham item.

For example, a set of texts corresponding to the advertising object may be determined in advance. The set of texts corresponding to the advertising objects may be stored in the server or in a database (DB) accessible from the server. The server may determine the text included in the set, to which the advertising object belongs, as the text corresponding to the advertising object. For example, “sausage,” “ham,” and the product names A, B, and C may be stored as texts belonging to the same set. When the product name of the advertising object is A, the server may identify the texts included in the same set as the product name A as the text corresponding to the advertising object.

Hereinafter, the text corresponding to the advertising object may be referred to as a replacement word.

The advertising target section may further include not only a section in which the replacement word is uttered, but also at least a partial section of the video preceding the section in which the replacement word is uttered, and/or at least a partial section of the video following the section in which the replacement word is uttered.

For example, the advertising target section may include a section in which a phrase including the replacement word is uttered. For example, when the replacement word is “sausage” and the phrase including the replacement word is “The sausage,” the advertising target section may include a section in which “The sausage” is uttered.

For example, the advertising target section may include a section in which a phrase including the replacement word, n phrases preceding the phrase including the replacement word (where n is any natural number), and/or m phrases following the phrase including the replacement word (where m is any natural number) are uttered.

For example, the advertising target section may include a section in which n words preceding the replacement word (where n is any natural number) and the replacement word are uttered. For example, the advertising target section may include a section in which the replacement word and n words following the replacement word (where n is any natural number) are uttered.

For example, the advertising target section may include a continuous speech section that includes utterance of the replacement word. The continuous speech section is a section from the start of a speech to the end of the speech, and may correspond to a section in which the speech is uttered in one breath by a person. The continuous speech section may be determined by changes in loudness of the speech.

For example, the advertising target section may be determined as a section with a predetermined length that includes utterance of the replacement word. For example, the advertising target section may be determined to include n frames (where n is any natural number) or may be determined as a section with a length of m seconds (where m is any positive real number). For example, the advertising target section may be determined to include a predetermined number of frames or a frame sequence with a predetermined length before and after the section in which the replacement word is uttered.

According to an embodiment, operation 110 of obtaining the advertising target section may include an operation of obtaining text data corresponding to an audio track, an operation of extracting a text corresponding to the advertising object from the text data, and an operation of obtaining the advertising target section corresponding to the text extracted from the video.

The video may be divided into an audio track and a video track. The audio track refers to auditory elements of the video and may include a sequence of sound type data included in the video. The video track refers to visual elements of the video and may include a frame sequence of images included in the video.

The text data corresponding to the audio track is text data corresponding to utterance included in the audio track, and may include, for example, at least one of subtitles, scripts, and data obtained by applying speech-to-text (STT) to the audio track.

For example, the operation of obtaining the text data corresponding to the audio track may include an operation of obtaining previously stored text data corresponding to the video. For example, subtitle data of the video may be stored in advance, and the server may obtain the previously stored subtitle data of the video.

In an example, the operation of obtaining the text data may include an operation of obtaining the text data by transcribing the audio track. The server may perform the STT operation on the audio track to obtain the text data corresponding to the audio track. Alternatively, the server may obtain the text data corresponding to the audio track by applying the audio track to an STT model.

A text corresponding to the advertising object, that is, the replacement word, may be extracted from the text data corresponding to the audio track. In an example, as described above, the server may determine a text included in the set, to which the advertising object belongs, as the text corresponding to the advertising object.

The server may determine a section in the video that contains the utterance of the extracted replacement word as the advertising target section.

According to an embodiment, operation 110 of obtaining the advertising target section may include an operation of extracting the advertising target section based on tagging information about the advertising object included in the video. For example, the video may include tagging information indicating the advertising target section corresponding to the advertising object. In other words, a specific section of the video may be tagged as the advertising target section corresponding to the advertising object. The server may extract a section in the video indicated by the tagging information as the advertising target section.

The advertising method according to an embodiment may include operation 120 of sampling speech data of a target speaker corresponding to the advertising target section from at least a portion of the audio track of the video. The target speaker may correspond to a speaker who has uttered the replacement word. The server may extract data corresponding to a speech of the target speaker from the video. Operation 120 of sampling the speech data of the target speaker will be described in detail below.

The advertising method according to an embodiment may include operation 130 of changing an audio track corresponding to the target speaker in the advertising target section into speech synthesis data of the target speaker uttering the advertising script regarding the advertising object based on the sampled speech data of the target speaker.

The advertising script for the advertising object is a script for advertising an advertising object, and may include, for example, at least one of a product name of the advertising object, a brand name of the advertising object, and a feature of the advertising object. For example, the advertising script may be input by an advertiser. For example, a word corresponding to the advertising object is input by the advertiser, and the server may generate the advertising script by changing the replacement word in the text data corresponding to the audio track of the advertising target section to the word corresponding to the advertising object.

The server may obtain speech synthesis data in which the advertising script is uttered in the voice of the target speaker, by applying the sampled speech data of the target speaker and the advertising script to a text-to-speech (TTS) model. Alternatively, the server may change an audio track corresponding to the target speaker in the advertising section to the speech synthesis data in which the advertising script is uttered in the voice of the target speaker, by applying the sampled speech data of the target speaker and the advertising script to a TTS model. The TTS model is a training-based model that generates utterance data of an input text in the voice of input speech data, and may include, for example, a zero-shot TTS model.

The obtained speech synthesis data may be data corresponding to the voice of the target speaker. For example, the speech synthesis data reflecting not only the voice of the target speaker, but also the speaking style of the target speaker, such as an intonation, speech style, utterance speed, and pitch of speech of the target speaker may be obtained.

The changed audio track of the advertising target section may include the speech synthesis data in which the advertising script is uttered in the voice of the target speaker. For example, when the audio track of the advertising target section includes not only the speech data of the target speaker but also other sound data (e.g., utterance data of other characters, sound effects, background music, sounds of objects, or the like), only the speech data portion of the target speaker may be changed in the audio track of the advertising target section. The other sound data may remain unchanged and remain as data included in original data.

The advertising method according to an embodiment may include operation 140 of changing a lip movement of the target speaker in the video track of the advertising target section to a lip movement for uttering the advertising script.

The server may obtain a video track, in which the lip movement of the target speaker is changed to the lip movement for uttering the advertising script, by applying the speech synthesis data obtained in operation 130 and the video track or original frame(s) included in the advertising target section to a speech-based lip movement synthesis model. The speech-based lip movement synthesis model may correspond to a training-based model that changes an input lip movement image into a lip movement image of input speech data.

According to an embodiment, operation 140 of changing the lip movement may include identifying a character estimated as the target speaker based on a lip movement pattern of a character of the video track of the advertising target section, and changing a lip movement of the character estimated as the target speaker in the video track of the advertising target section to the lip movement for uttering the advertising script.

The video track of the advertising target section may include one or more characters. For example, the server may estimate a character moving his or her lips in the advertising target section as the target speaker. For example, the server may estimate a character moving his or her lips at an utterance time point of the replacement word as the target speaker. For example, the server may estimate a character with the lip movement in the advertising target section corresponding to the replacement word, as the target speaker.

According to an embodiment, operation 140 of changing the lip movement may include segmenting a mouth region of a character in the video track of the advertising target section, and obtaining the video track of the advertising target section, in which the mouth region is changed to have the lip movement for uttering the advertising script. Instead of changing the entire frame of the advertising target section, the server may change only the mouth region which is a partial region of the frame, thereby obtaining the video track in which the lip movement is changed with a less amount of computation than when the entire frame is changed.

The advertising target section may be changed to a video including the speech synthesis data of the target speaker uttering the advertising script and the video track in which the lip movement of the target speaker is changed to the lip movement for uttering the advertising script by operations 130 and 140. For example, the audio track of the advertising target section may be replaced with the speech synthesis data obtained in operation 130, and the video track of the advertising target section may be replaced with the video track obtained in operation 140.

The advertising method according to an embodiment may include an operation of changing an image corresponding to a replacement word included in the video track of the advertising target section to an image of the advertising object. The server may recognize an image corresponding to the replacement word in the frame(s) included in the video track. For example, when the replacement word is sausage, the server may identify a sausage image included in the frame(s) included in the video track. The server may receive an image of the advertising object, and change an image corresponding to the replacement word in the frame(s) included in the video track of the advertising target section to the image of the advertising object. For example, when the advertising object is a sausage with the product name A, the server may change the sausage image included in the frame(s) included in the video track to an image of the sausage with the product name A.

The advertising method according to an embodiment may allow the advertising target section to be automatically changed to a video in which the advertising script for the advertising object is uttered. In order to change the advertising object that is indirectly advertised through the video, the advertising target section may be changed to a video including utterance regarding the changed advertising object by using the advertising method according to an embodiment, without having to re-film the video in which an actual character utters the advertising script regarding the changed advertising object.

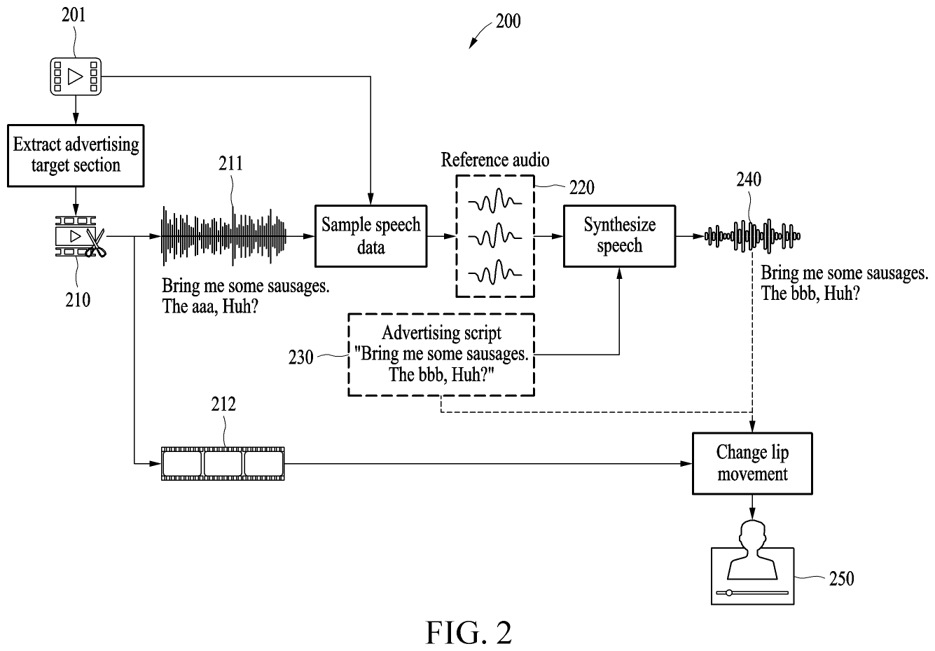

FIG. 2 is a diagram illustrating a framework of a model for performing an advertising method according to an embodiment.

Hereinafter, a model for performing the advertising method may be simply referred to as an advertising model. The operation of the advertising model described with reference to FIG. 2 may be implemented in a server described above with reference to FIG. 1. The operation performed in an advertising model 200 described with reference to FIG. 2 may correspond to the operation of the server described above with reference to FIG. 1.

Referring to FIG. 2, the advertising model 200 may extract an advertising target section 210 from an input video 201. As described above, a partial frame sequence in a video including a section in which a replacement word is uttered may be extracted as the advertising target section 210 from the input video 201. For example, the replacement word may be “aaa,” and an utterance section of “Bring me some sausages. The aaa, huh?” that includes the utterance of “aaa” may be extracted as the advertising target section 210.

The advertising target section 210 may be separated into an audio track 211 including auditory elements and a video track 212 including visual elements.

The advertising model 200 may sample speech data of a target speaker from the input video 201 based on the audio track 211 of the advertising target section 210. The target speaker may correspond to an utterer of the audio track 211, that is, a speaker who has uttered the replacement word. The sampled speech data of the target speaker may be referred to as reference audio 220.

The advertising model 200 may synthesize a speech of the target speaker who utters an advertising script 230 regarding an advertising object based on the reference audio 220. For example, the advertising script 230 may correspond to “bbb” or “Bring me some sausages. The bbb, huh?,” in which the replacement word in a text corresponding to the advertising target section 210 is changed to “bbb”. Speech synthesis data 240 in which “Bring me some sausages. The bbb, huh?” is uttered in the voice of the target speaker may be generated.

The advertising model 200 may change a lip movement of the advertising target speaker in the video track 212 of the advertising target section 210 based on at least one of the advertising script 230 and the speech synthesis data 240. A video track 250 in which the lip movement of the target speaker is changed to a lip movement corresponding to the speech synthesis data 240, that is, a lip movement for uttering the advertising script 230 may be generated.

A replaced video corresponding to the advertising object of the advertising target section 210 may be obtained by combining the speech synthesis data 240 and the video track 250 in which the lip movement of the target speaker is changed.

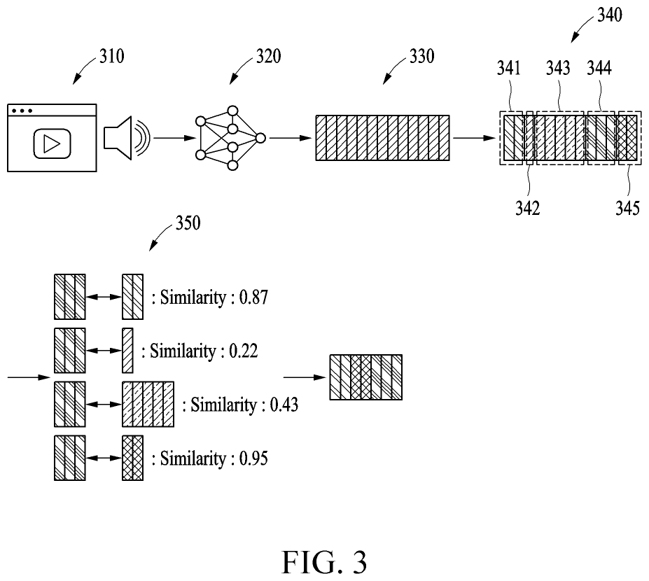

FIG. 3 is a diagram illustrating a method of sampling speech data of a target speaker according to an embodiment.

Referring to FIG. 3, operation 120 of sampling the speech data of the target speaker described above with reference to FIG. 1 may include an operation of obtaining section-wise embedding data 330 of an audio track 310 by applying the audio track 310 of the video to a speech encoder 320, and an operation of extracting a section, in which it is determined that the target speaker has uttered, based on a similarity between the section-wise embedding data 330.

According to an embodiment, the section-wise embedding data 330 may be clustered based on the similarity between each other. The operation of extracting the section, in which it is determined that the target speaker has uttered, may include an operation of obtaining a similarity 350 between each of clusters 341, 342, 343, and 345 obtained as a result 340 of clustering the section-wise embedding data 330 and a cluster 344 of the advertising target section, and an operation of extracting a section corresponding to the clusters 341 and 345 that are determined to have the same speaker as the cluster 344 of the advertising target section based on the similarity 350.

For example, it may be determined that clusters having the similarity with the cluster 344 of the advertising target section being greater than or equal to a threshold value (e.g., 0.8) or top n clusters or m % of clusters having a high similarity with the cluster 344 of the advertising target section have the same speaker as the cluster 344 of the advertising target section.

In the audio track of the video, a portion indicated by the clusters 341 and 345 determined to have the same speaker as the cluster 344 of the advertising target section may be sampled as the speech data of the target speaker.

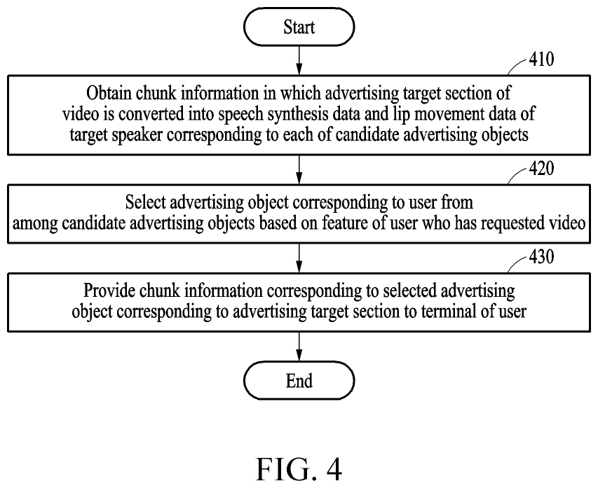

FIG. 4 is a flowchart of an operation of an advertising method for providing a video including a customized advertising target section according to an embodiment.

Referring to FIG. 4, the advertising method according to an embodiment may include operation 410 of obtaining chunk information in which an advertising target section of a video is converted into speech synthesis data and lip movement data of a target speaker corresponding to each of candidate advertising objects.

The candidate advertising objects may be included in a group corresponding to the advertising target section. For example, when the advertising target section includes the utterance of “sausage” or a product name of a sausage item, the product names of the sausage item and/or the product names of a ham item similar to the sausage may be included in the same group, and the candidate advertising objects may include at least some of the product names of sausage item and the product names of the ham item similar to the sausage.

Chunk information corresponding to the candidate advertising object may include a replaced video with the advertising target section that is changed to include the utterance of an advertising script regarding the candidate advertising object, or information for generating (or playing) a replaced video with the advertising target section that is changed to include the utterance of an advertising script regarding the candidate advertising object.

The replaced video of the advertising target section corresponding to the candidate advertising object may include speech synthesis data in which the advertising script regarding the candidate advertising object is uttered in the voice of the target speaker, and a video track in which the lip movement of the target speaker is converted into a lip movement for uttering the advertising script for the candidate advertising object.

The chunk information corresponding to the candidate advertising object may be generated according to the advertising method described above with reference to FIG. 1. For example, operation 410 of obtaining the chunk information may include an operation of obtaining the advertising target section from the video, an operation of sampling speech data of the target speaker corresponding to the advertising target section from an audio track of the video, an operation of synthesizing a speech of the target speaker uttering the advertising script regarding each candidate advertising object based on the sampled speech data of the target speaker, an operation of changing a lip movement of the target speaker in a video track of the advertising target section to a lip movement for uttering the advertising script regarding each candidate advertising object, and an operation of generating a chunk corresponding to each candidate advertising object, in which the advertising target section is changed into a video track including the changed lip movement and the synthesized speech data.

The advertising method according to an embodiment may include operation 420 of selecting an advertising object corresponding to a user from among the candidate advertising objects based on a feature of the user who requested the video. The user is a user who uses the service, and the feature of the user may include at least one of the user's gender, age, residence, and video viewing history information that may be obtained from the server. For example, the server may select the candidate advertising object that corresponds to the feature of the user using a recommendation logic. For example, the server may select the candidate advertising object determined to be preferred by the user using the recommendation logic.

The advertising method according to an embodiment may include operation 430 of providing chunk information corresponding to the selected advertising object corresponding to the advertising target section to a terminal of the user. The server may provide, to the terminal of the user, the chunk information corresponding to the candidate advertising object selected in operation 420 among the chunk information corresponding to each of the plurality of candidate advertising objects that is already obtained in operation 410.

As described above, the chunk information may include a video with a advertising target section changed corresponding to the candidate advertising object or information for generating the video.

For example, operation 430 of providing the chunk information may include an operation of providing the video to the terminal of the user by replacing the advertising target section with a video segment corresponding to the chunk information. When the video is played on the terminal of the user, the replaced video with the advertising target section that is received from the server may be played.

For example, the terminal of the user may play the video with the replaced advertising target section based on the chunk information corresponding to the advertising target section received from the server. The video with the replaced advertising target section including the utterance of the advertising script regarding the advertising object selected in response to the user based on the chunk information received from the server may be synthesized and replayed on the terminal of the user.

According to an embodiment, operations 410 and 420 may be performed serially or in parallel. For example, operation 420 may be performed after operation 410 is performed. For example, operation 410 may be performed after operation 420 is performed. For example, operations 410 and 420 may not be performed in this order and may be performed independently of each other.

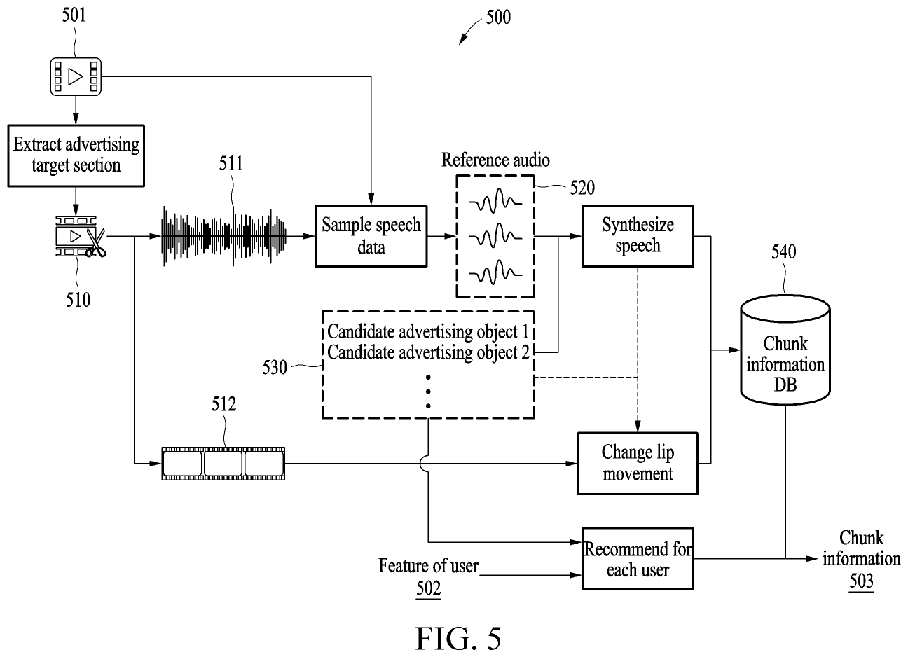

FIG. 5 is a diagram illustrating a framework of a model for performing an advertising method according to an embodiment.

Hereinafter, a model for performing the advertising method may be simply referred to as an advertising model. An advertising model 500 described with reference to FIG. 5 may correspond to the advertising model 200 described with reference to FIG. 2. The operation of the advertising model 500 described with reference to FIG. 5 may be implemented in the server described above with reference to FIG. 1 and/or the server described above with reference to FIG. 4. The operation performed in the advertising model 500 described with reference to FIG. 5 may correspond to the operation of the server described above with reference to FIG. 1 and/or the server described above with reference to FIG. 4.

Referring to FIG. 5, the advertising model 500 may generate chunk information corresponding to each of candidate advertising objects 530 included in one group corresponding to the advertising target section. The chunk information corresponding to the candidate advertising object may include a replaced video with the advertising target section that is changed to include the utterance of an advertising script regarding the candidate advertising object, or information for generating a replaced video with the advertising target section that is changed to include the utterance of an advertising script regarding the candidate advertising object.

The replaced video with the advertising target section corresponding to the candidate advertising object may include speech synthesis data in which an advertising script regarding the candidate advertising object is uttered in the voice of a target speaker, and a video track in which a lip movement of the target speaker is converted into a lip movement for uttering the advertising script regarding the candidate advertising object.

The speech synthesis data in which the advertising script regarding the candidate advertising object is uttered in the voice of the target speaker may be obtained by synthesizing the speech of the target speaker uttering the advertising script regarding the candidate advertising object based on a reference audio 520. As described above, the reference audio 520 may be obtained by sampling the speech data of the target speaker in an input video 501 based on an audio track 511 of an advertising target section 510. An operation of extracting the advertising target section 510 and sampling the speech data of the target speaker to obtain the reference audio 520 may correspond to the operation described above with reference to FIGS. 1 and 2.

The video track in which the lip movement of the target speaker is converted into the lip movement for uttering the advertising script regarding the candidate advertising object may be obtained by changing the lip movement of the advertising target speaker in a video track 512 with the advertising target section 510 based on at least one of the advertising script regarding the candidate advertising object and the speech synthesis data.

The chunk information in which the advertising target section 510 is converted into speech synthesis data of the target speaker and lip movement data corresponding to each candidate advertising object may be stored in a chunk information DB 540 for storing the chunk information. The chunk information DB 540 may be an internal memory of the server or an external memory accessible from the server.

A request to play the video 501 may be received from the terminal of the user using the service. The advertising model 500 may obtain a feature 502 of the user who has requested the playback of the video 501. For example, the advertising model 500 may select an advertising object that corresponds to the feature 502 of the user from among candidate advertising objects 530 using a recommendation logic. The advertising model 500 may output chunk information 503 of the selected advertising object stored in the chunk information DB 540 in order to provide it to the user of the terminal.

The chunk information of the advertising target section corresponding to each of candidate advertising objects 530 may be generated and stored in advance, and the chunk information 503 corresponding to the advertising object recommended in response to the user may be provided to the terminal of the user who has requested the playback of the video 501, thereby providing a video changed to include a customized advertisement.

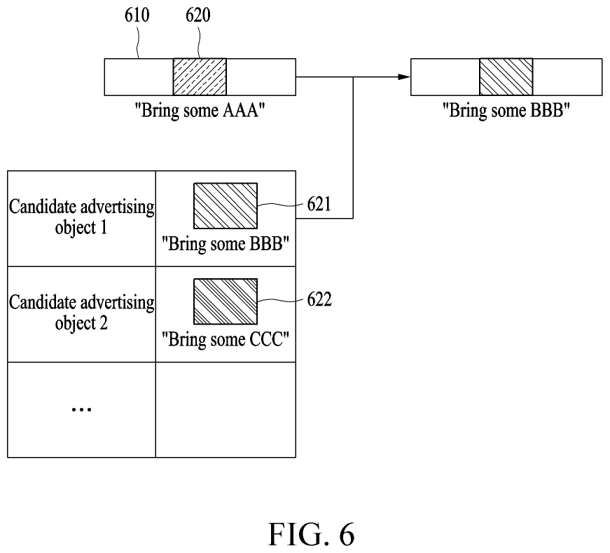

FIG. 6 is a diagram illustrating an operation of providing a customized advertising target section according to an embodiment.

Referring to FIG. 6, an advertising target section 620 of a video 610 may be changed to a video corresponding to each candidate advertising object.

For example, when the advertising target section 620 of the original video 610 includes the utterance of “Bring me some AAA,” chunk information 621 and 622 corresponding to a candidate advertising object 1 and a candidate advertising object 2 belonging to the same group as “AAA” may be generated.

For example, when the product name of the candidate advertising object 1 is “BBB,” the chunk information 621 corresponding to the candidate advertising object 1 may correspond to a video segment that includes the utterance “Bring me some BBB.”

For example, when the product name of the candidate advertising object 2 is “CCC,” the chunk information 622 corresponding to the candidate advertising object 2 may correspond to a video segment that includes the utterance “Bring me some CCC.”

When the candidate advertising object 1 is selected in response to the user who has requested the playback of a video, the advertising target section 620 may be changed to the chunk information 621 corresponding to the candidate advertising object 1 and played on the terminal of the user. The advertising target section 620 may be changed to a video that includes the utterance “Bring me some BBB” instead of “Bring me AAA” and played on the terminal of the user.

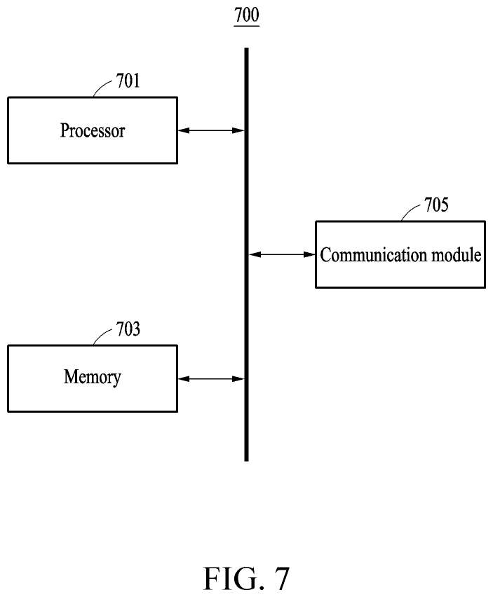

FIG. 7 is a diagram illustrating an example of a configuration of a server according to an embodiment.

Referring to FIG. 7, a server 700 may include a processor 701, a memory 703, and a communication module 705. The server 700 according to an embodiment may include a server that performs the advertising method described above with reference to FIGS. 1 to 6.

The processor 701 according to an embodiment may perform at least one operation of the advertising method described above with reference to FIGS. 1 to 6. For example, the processor 701 may perform at least one of an operation of obtaining a advertising target section from a video, an operation of sampling speech data of a target speaker corresponding to the advertising target section from an audio track of the video, an operation of synthesizing a speech of the target speaker uttering an advertising script regarding the advertising object based on the sampled speech data of the target speaker, an operation of changing a lip movement of the target speaker in a video track of the advertising target section to a lip movement for uttering the advertising script, and an operation of changing the advertising target section to a video track including the changed lip movement and the synthesized speech data. For example, the processor 701 may perform at least one of an operation of obtaining chunk information in which an advertising target section of a video is converted into speech synthesis data and lip movement data of a target speaker corresponding to each of candidate advertising objects, an operation of selecting an advertising object corresponding to a user from among the candidate advertising objects based on a feature of the user who has requested the video, and an operation of providing chunk information corresponding to the selected advertising object corresponding to the advertising target section to a terminal of the user.

The memory 703 may be a volatile or non-volatile memory, and may store data related to the advertising method described with reference to FIGS. 1 to 6. For example, the memory 703 may store data generated during the process of performing the advertising method or data necessary for performing the advertising method. For example, the memory 703 may store a set of texts corresponding to an advertising object and/or group information corresponding to an advertising target section. For example, the memory 703 may store chunk information corresponding to a candidate advertising object.

The communication module 705 may provide a function for the server 700 to communicate with other electronic devices or other servers through a network. In other words, the server 700 may be connected to an external device (e.g., a terminal of a user, a server, or a network) through the communication module 705 and exchange data with the external device. For example, the server 700 may transmit and receive data with another server included in an advertising system through the communication module 705. For example, the server 700 may transmit and receive data with the terminal of a user or an advertiser who has requested the advertisement through the communication module 705.

According to an embodiment, the memory 703 may store a program implementing the targeting advertising method described above with reference to FIGS. 1 to 6. The processor 701 may execute the program stored in the memory 703 and may control the server 700. Code of the program executed by the processor 701 may be stored in the memory 703.

The memory 703 may store instructions.

For example, the instructions, when executed by the processor 701, may cause the server 700 to perform an operation of obtaining an advertising target section from a video, an operation of sampling speech data of a target speaker corresponding to the advertising target section from an audio track of the video, an operation of synthesizing a speech of the target speaker uttering an advertising script regarding an advertising object based on the sampled speech data of the target speaker, an operation of changing a lip movement of the target speaker in a video track of the advertising target section to a lip movement for uttering the advertising script, and an operation of changing the advertising target section to a video track including the changed lip movement and the synthesized speech data.

For example, the instructions, when executed by the processor 701, may cause the server 700 to perform an operation of obtaining chunk information in which an advertising target section of a video is converted into speech synthesis data and lip movement data of a target speaker corresponding to each of candidate advertising objects, an operation of selecting an advertising object corresponding to a user from among the candidate advertising objects based on a feature of the user who has requested the video, and an operation of providing chunk information corresponding to the selected advertising object corresponding to the advertising target section to a terminal of the user.

The server 700 may further include other components not shown in the drawings. For example, the server 700 may further include an input/output interface including an input device and an output device as the means of interfacing with the communication module 705. In addition, for example, the server 700 may further include other components such as a transceiver, various sensors, and a DB.

The server 700 executing the method includes specialized components such as a trained text-to-speech (TTS) engine, speech embedding encoder, and a lip synchronization model, each configured to process audiovisual content in real time. These components interact in a defined sequence to enable transformation of media segments, and the server is not merely executing generic functions but performing operations that are tailored for media synthesis and personalization.

In some embodiments, the disclosed system processes multimodal input data—audio tracks, video frames, and user profile information—to produce a concrete output, namely a modified video segment that includes synthesized speech and altered visual content. This improves the efficiency of personalized video delivery in streaming systems by avoiding the need for rendering or transmitting multiple full-length versions of the same media.

Various embodiments of the disclosed method and system enable the insertion of personalized advertisements into existing video content by modifying audio and visual elements in real time. It detects relevant sections of a video where product references appear and replaces those segments with customized content. The new content includes speech synthesized to match the voice characteristics of the original speaker, such as tone, speaking rate, and style. Simultaneously, the visual component is updated by altering the character's lip movements to correspond with the synthesized speech. In some implementations, only the mouth region is modified to reduce processing demands.

The technical features of the system include the use of advanced speech synthesis models, such as text-to-speech engines that replicate speaker-specific voice traits, and lip synchronization models driven by speech data. The method also uses speech embedding and clustering techniques to identify and extract relevant speaker segments. Multiple advertisement segments are generated in advance for each target section, and the system selects the most appropriate version based on user-specific data such as geographic location, demographic profile, or viewing behavior. This allows for individualized advertisement delivery within streaming or video-on-demand platforms without requiring manual editing or content reshooting.

The embodiments described herein may be implemented using a hardware component, a software component and/or a combination thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combinations thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other examples, and equivalents to the claims are also within the scope of the following claims.

As described above, the disclosed method and system address a specific technical challenge in digital media delivery—namely, how to dynamically modify audiovisual content to include personalized advertising without requiring the production or transmission of multiple full versions of a video. Traditional systems often rely on manual editing, static overlays, or non-synchronized ad insertions, which lack scalability and visual coherence for real-time personalization. In contrast, the present system provides a concrete technological solution by identifying a target section within a video, sampling speech data of a target speaker, and generating speech synthesis data in the speaker's voice for an advertising script corresponding to a selected advertising object. Simultaneously, the speaker's lip movements in the video are modified to match the synthesized utterance using a speech-driven lip synchronization model. These operations are performed by a server comprising specialized processing components such as a speech encoder, clustering engine, text-to-speech model, and video track editor. The result is a modified audiovisual segment-referred to as chunk information—which includes both the synthesized speech and the corresponding video modifications. Chunk information can be pre-generated and stored for multiple candidate advertising objects. At playback time, only the chunk corresponding to a target object selected based on user-specific data is streamed or substituted into the video. This coordinated process improves bandwidth efficiency, reduces server-side rendering load, and enables seamless, scalable, and high-fidelity in-stream ad personalization on real-time or on-demand video platforms.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of video synthesis performed by a server, the method comprising:
obtaining a target section from a video;
sampling speech data of a target speaker corresponding to the target section from at least a portion of an audio track of the video;
changing an audio track corresponding to the target speaker in the target section into speech synthesis data of the target speaker uttering a script regarding a target object based on the sampled speech data of the target speaker; and
changing a lip movement of the target speaker in a video track of the target section to a lip movement for uttering the script.

2. The method of claim 1, wherein the obtaining of the target section comprises:
obtaining text data corresponding to the audio track;
extracting a text corresponding to the target object from the text data; and
obtaining the target section corresponding to the extracted text from the video.

3. The method of claim 2, wherein the obtaining of the text data comprises at least one of:
obtaining the text data previously stored corresponding to the video; and
obtaining the text data by transcribing the audio track.

4. The method of claim 1, wherein the obtaining of the target section comprises:
extracting the target section based on tagging information about the target object included in the video.

5. The method of claim 1, wherein the sampling of the speech data of the target speaker comprises:
obtaining section-wise embedding data of the audio track by applying the audio track to a speech encoder; and
extracting a section, in which it is determined that the target speaker has uttered, based on a similarity between the section-wise embedding data.

6. The method of claim 5, wherein the extracting of the section, in which it is determined that the target speaker has uttered, comprises:
obtaining a similarity between each cluster obtained as a result of clustering the section-wise embedding data and a cluster of the target section; and
extracting a section corresponding to a cluster that is determined to have the same speaker as the cluster of the target section based on the similarity.

7. The method of claim 1, wherein the changing of the lip movement comprises:
identifying a character estimated as the target speaker based on a lip movement pattern of a character of the video track of the target section; and
changing a lip movement of the character estimated as the target speaker in the video track of the target section to the lip movement for uttering the script.

8. The method of claim 1, wherein the changing of the lip movement comprises:
segmenting a mouth region of a character in the video track of the target section; and
obtaining the video track of the target section, in which the mouth region is changed to have the lip movement for uttering the script.

9. A method of video synthesis performed by a server, the method comprising:
obtaining chunk information in which a target section of a video is converted into speech synthesis data and lip movement data of a target speaker corresponding to each of candidate objects;
selecting a target object corresponding to a user from among the candidate objects based on a feature of the user who has requested the video; and
providing chunk information for the selected target object, associated with the target section to a terminal of the user.

10. The method of claim 9, wherein the obtaining of the chunk information comprises:
obtaining the target section from the video;
sampling speech data of a target speaker corresponding to the target section from an audio track of the video;
synthesizing a speech of the target speaker uttering a script regarding each candidate object based on the sampled speech data of the target speaker;
changing a lip movement of the target speaker in a video track of the target section to a lip movement for uttering the script regarding each candidate object; and
generating, for each candidate object, a chunk in which the corresponding target section is changed into a video track including the changed lip movement and the synthesized speech.

11. The method of claim 9, wherein the providing of the chunk information comprises:
providing the video to the terminal of the user by replacing the target section with a video segment corresponding to the chunk information.

12. The method of claim 9, wherein the terminal of the user plays a replaced video with the target section based on the chunk information.

13. The method of claim 9, wherein the candidate objects are included in one group corresponding to the target section.

14. A non-transitory computer-readable storage medium storing instructions that, when executed by a processor, cause the processor to perform the method of claim 1.

15. A server, comprising:
at least one processor including processing circuitry; and
memory storing instructions that, when executed by the at least one processor individually or collectively, cause the server to:
obtain a target section from a video;
sample speech data of a target speaker corresponding to the target section from at least a portion of an audio track of the video;
change an audio track corresponding to the target speaker in the target section into speech synthesis data of the target speaker uttering a script regarding a target object based on the sampled speech data of the target speaker; and
change a lip movement of the target speaker in a video track of the target section to a lip movement for uttering the script.

16. The server of claim 15, wherein the instructions, when executed by the at least one processor individually or collectively, cause the server to:
obtain text data corresponding to the audio track;
extract a text corresponding to the target object from the text data; and
obtain the target section corresponding to the extracted text from the video.

17. The server of claim 15, wherein the instructions, when executed by the at least one processor individually or collectively, cause the server to:
obtain the text data previously stored corresponding to the video; and
obtain the text data by transcribing the audio track.

18. The server of claim 15, wherein the instructions, when executed by the at least one processor individually or collectively, cause the server to:
obtain section-wise embedding data of the audio track by applying the audio track to a speech encoder; and
extract a section, in which it is determined that the target speaker has uttered, based on a result of clustering of the section-wise embedding data.

19. The server of claim 15, wherein the instructions, when executed by the at least one processor individually or collectively, cause the server to:
identify a character estimated as the target speaker based on a lip movement pattern of a character of the video track of the target section; and
change a lip movement of the character estimated as the target speaker in the video track of the target section to the lip movement for uttering the script.

20. A server, comprising:
at least one processor including processing circuitry; and
memory storing instructions that, when executed by the at least one processor individually or collectively, cause the server to:
obtain chunk information in which a target section of a video is converted into speech synthesis data and lip movement data of a target speaker corresponding to each of candidate objects;
select a target object corresponding to a user from among the candidate objects based on a feature of the user who has requested the video; and
provide chunk information corresponding to the selected target object corresponding to the target section to a terminal of the user.
